(19) United States
(12) Patent Application Publication
(10) Pub. No.: US 2026/0042482 A1
(43) Pub. Date: Feb. 12, 2026

(54) SYSTEMS AND METHODS FOR RACK POSITION OFFSET LEARNING

(71) Applicant: Steering Solutions IP Holding Corporation, Saginaw, MI (US)

(72) Inventors: Xue ZHANG, Suzhou, Jiangsu (CN); Jovan LI, Suzhou (CN); Felix LU, Suzhou (CN); Bing TONG, Suzhou (CN)

(21) Appl. No.: 18/802,527

(22) Filed: Aug. 13, 2024

(30) Foreign Application Priority Data
Aug. 7, 2024 (CN) 2024110779148

(51) Int. Cl. B62D 6/00

(52) U.S. Cl. CPC B62D 6/00

(57) ABSTRACT

A method for rack position offset learning includes receiving at least one vehicle characteristic value, and determining, based on the at least one vehicle characteristic value, whether a vehicle associated with the at least one vehicle characteristic value is traveling in a straight line. The method also includes, calculating, for a predetermine period, a straight line distance traveled by the vehicle based on a vehicle speed and a length of the predetermined period. The method also includes determining whether the calculated straight line distance is greater than or equal to a straight line distance threshold, starting a counter, and, in response to a counter value of the counter being greater than or equal to a counter threshold, determining a rack position offset value based on a rack position of a rack of a steering system of the vehicle.

### CROSS REFERENCE TO RELATED APPLICATION

This application claims priority to Chinese Patent Application No. 2024110779148, filed August 7, 2024, the disclosure of which is incorporated by reference herein in its entirety.

### TECHNICAL FIELD

This disclosure relates to steering systems, and in particular, to systems and methods for rack position offset learning in steering systems.

### BACKGROUND

A vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

### SUMMARY

This disclosure relates generally to steering systems.

An aspect of the disclosed embodiments includes a system for rack position offset learning. The system includes a processor, and a memory. The memory includes instructions that, when executed by the processor, cause the processor to: receive at least one vehicle characteristic value; determine, based on the at least one vehicle characteristic value, whether a vehicle associated with the at least one vehicle characteristic value is traveling in a straight line; in response to a determination that the vehicle is traveling in a straight line, calculate, for a predetermine period, a straight line distance traveled by the vehicle based on a vehicle speed and a length of the predetermined period; determine whether the calculated straight line distance is greater than or equal to a straight line distance threshold; in response to a determination that the calculated straight line distance is greater than or equal to the straight line distance threshold, start a counter; and, in response to a counter value of the counter being greater than or equal to a counter threshold, determine a rack position offset value based on a rack position of a rack of a steering system of the vehicle.

Another aspect of the disclosed embodiments includes a method for rack position offset learning. The method includes receiving at least one vehicle characteristic value, and determining, based on the at least one vehicle characteristic value, whether a vehicle associated with the at least one vehicle characteristic value is traveling in a straight line. The method also includes, in response to a determination that the vehicle is traveling in a straight line, calculating, for a predetermine period, a straight line distance traveled by the vehicle based on a vehicle speed and a length of the predetermined period. The method also includes determining whether the calculated straight line distance is greater than or equal to a straight line distance threshold, in response to a determination that the calculated straight line distance is greater than or equal to the straight line distance threshold, starting a counter, and, in response to a counter value of the counter being greater than or equal to a counter threshold, determining a rack position offset value based on a rack position of a rack of a steering system of the vehicle.

Another aspect of the disclosed embodiments includes an apparatus for rack position offset learning. The apparatus includes a controller configured to: receive at least one vehicle characteristic value; determine, based on the at least one vehicle characteristic value, whether a vehicle associated with the at least one vehicle characteristic value is traveling in a straight line; in response to a determination that the vehicle is traveling in a straight line, calculate, for a predetermine period, a straight line distance traveled by the vehicle based on a vehicle speed and a length of the predetermined period; determine whether the calculated straight line distance is greater than or equal to a straight line distance threshold; in response to a determination that the calculated straight line distance is greater than or equal to the straight line distance threshold, start a counter; in response to a counter value of the counter being greater than or equal to a counter threshold, determine a rack position offset value based on a rack position of a rack of a steering system of the vehicle; and adjust a position of the rack based on the rack position offset value.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIGS. 3A and 3B generally illustrate block diagrams of rack position offset learning according to the principles of the present disclosure.

FIG. 4 is a flow diagram generally illustrating a rack position offset learning method according to the principles of the present disclosure.

FIG. 5 is a flow diagram generally illustrating an alternative rack position offset learning method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an EPS system, an SbW steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

In a SbW steering system, there is no mechanical connection between road wheels and steering wheel. A roadwheel actuator (RWA) and a handwheel actuator (HWA) are separate mechanical systems which work independently. To ensure the vehicle is traveling on a straight trajectory, in a traditional EPS steering system a handwheel angle offset is used. However, for the SbW steering system, it may be necessary to find and/or learn the absolute 0 rack position (e.g., the offset), to synchronize to a 0 handwheel angle.

Due to the separate structure of the SbW steering system, inputs used to estimate the rack position offset in an EP steering system (e.g., including handwheel angle, handwheel velocity, handwheel torque), may not be useful for estimating the rack position offset in the SbW steering system.

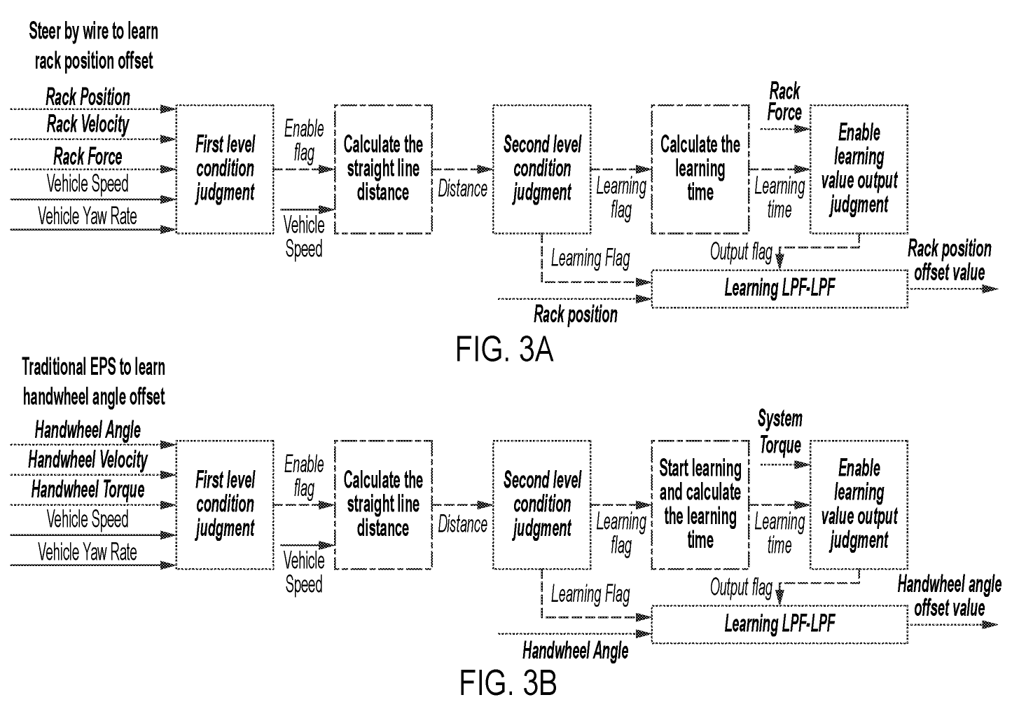

Accordingly, systems and methods, such as those described herein, configured to provide improved rack position offset learning, may be desirable. With reference to FIGS. 3A and 3B, the inputs illustrated is the schematic diagrams show the differences between traditional EPS steering systems and SbW steering systems. For example, as is illustrated in FIG. 3A, the SbW steering system inputs used to learn rack position offset includes rack position, rack velocity, rack force, vehicle speed, and vehicle yaw rate. Alternatively, as is illustrated in FIG. 3B, the EPS steering system inputs used to learn rack position offset includes handwheel angle, handwheel velocity, handwheel torque, vehicle speed, and vehicle yaw rate.

In some embodiments, as is generally illustrated in FIG. 3A, the systems and methods described herein may be configured to perform a first level condition judgement based on one or more of the rack position, the rack velocity, the rack force, the vehicle speed, and the vehicle yaw rate. The systems and methods described herein may be configured to calculate a straight line distance based on enable flag, and a vehicle speed.

The systems and methods described herein may be configured to perform a second level condition judgment based on the distance. The systems and methods described herein may be configured to start learning and calculate the learning time based on a learning flag. The systems and methods described herein may be configured to enable a learning value output judgement based on a rack force and the learning time. The systems and methods described herein may be configured to perform learning (e.g., using a low pass filter) based on an output flag, a learning flag, and a rack position.

In some embodiments, the systems and methods described herein may be configured to provide rack position offset learning. In some embodiments, the systems and methods described herein may be configured to enter the offset learning accurately when it is time to study and ensure the accuracy of offset learning. In some embodiments, the systems and methods described herein may be configured to perform a judgment condition based on rack force, rack position, rack velocity, vehicle speed, and yaw rate.

In some embodiments, the systems and methods described herein may be configured to ensure the vehicle going straight, without using handwheel angle offset. In some embodiments, the systems and methods described herein may be configured to determine the absolute 0 rack position (e.g., offset), and synchronize to 0 handwheel angle. In some embodiments, the systems and methods described herein may be configured to use variables related to the rack, such as rack position, rack velocity, rack force, rather than using on steering wheel-related signals (e.g., handwheel angle, handwheel velocity, handwheel torque). In some embodiments, the systems and methods described herein may be configured to provide rack position offset learning for a SbW-RWA.

In some embodiments, the systems and methods described herein may be configured to provide rack position offset learning. The systems and methods described herein may be configured to receive at least one vehicle characteristic value. The at least one vehicle characteristic may include at least one of a rack position, a vehicle speed, a rack velocity of the rack, a rack force of the rack, a vehicle yaw rate, or other suitable vehicle characteristic value. The systems and methods described herein may be configured to determine, based on the at least one vehicle characteristic value, whether a vehicle associated with the at least one vehicle characteristic value is traveling in a straight line.

The systems and methods described herein may be configured to, in response to a determination that the vehicle is traveling in a straight line, calculate, for a predetermine period, a straight line distance traveled by the vehicle based on a vehicle speed and a length of the predetermined period.

The systems and methods described herein may be configured to determine whether the calculated straight line distance is greater than or equal to a straight line distance threshold. The systems and methods described herein may be configured to, in response to a determination that the calculated straight line distance is greater than or equal to the straight line distance threshold, start a counter.

The systems and methods described herein may be configured to, in response to a counter value of the counter being greater than or equal to a counter threshold, determine a rack position offset value based on a rack position of a rack of a steering system of the vehicle. The rack position of the rack may correspond to a zero position of the rack or other suitable position of the rack. The steering system may include a SbW steering system or other suitable steering system.

In some embodiments, the systems and methods described herein may be configured to determine the rack position offset value based on the rack position of the rack of the steering system of the vehicle using at least one low pass filter. The systems and methods described herein may be configured to use the low pass filter to limit the rack position offset value.

The systems and methods described herein may be configured to adjust a position of the rack based on the rack position offset value. For example, the systems and methods described herein may be configured to synchronize the rack to a handwheel angle zero position or other suitable position.

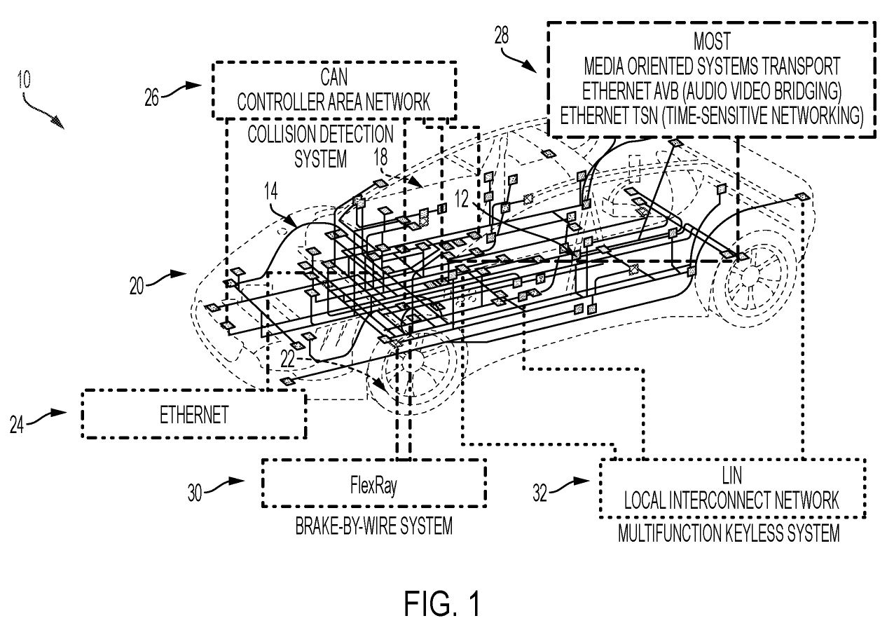

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

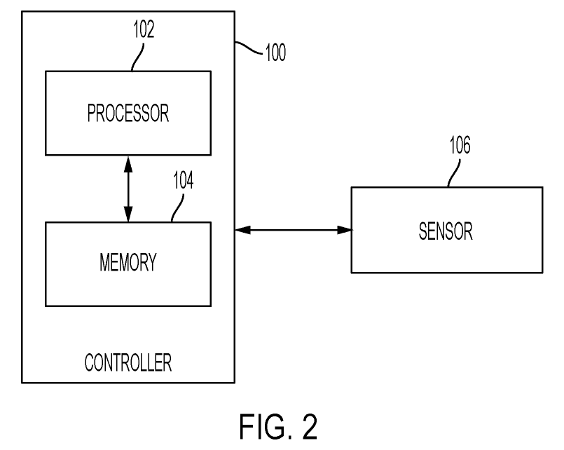

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more radar sensors or devices, one or more lidar sensors or devices, one or more sonar sensors or devices, one or more image capturing sensors or devices, other suitable sensors or devices, or a combination thereof. The one or more signals may indicate a handwheel torque, a handwheel angle, a motor velocity, a vehicle speed, other suitable information, or a combination thereof.

In some embodiments, the controller 100 may be configured to provide rack position offset learning. For example, the controller 100 may receive at least one vehicle characteristic value of the vehicle 10. The at least one vehicle characteristic may include at least one of a rack position, a vehicle speed, a rack velocity of the rack, a rack force of the rack, a vehicle yaw rate, or other suitable vehicle characteristic value. The controller 100 may determine, based on the at least one vehicle characteristic value, whether the vehicle 10 is traveling in a straight line (e.g., a straight trajectory) or substantially a straight line.

The controller 100 may, in response to a determination that the vehicle 10 is traveling in a straight line, calculate, for a predetermine period, a straight line distance traveled by the vehicle 10 based on a vehicle speed and a length of the predetermined period.

The controller 100 may determine whether the calculated straight line distance is greater than or equal to a straight line distance threshold. The controller 100 may, in response to a determination that the calculated straight line distance is greater than or equal to the straight line distance threshold, start a counter.

The controller 100 may, in response to a counter value of the counter being greater than or equal to a counter threshold, determine a rack position offset value based on a rack position of a rack of a steering system of the vehicle 10. The rack position of the rack may correspond to a zero position of the rack or other suitable position of the rack.

In some embodiments, the controller 100 may determine the rack position offset value based on the rack position of the rack of the steering system of the vehicle using at least one low pass filter. The controller 100 may use the low pass filter to limit the rack position offset value.

The controller 100 may adjust a position of the rack based on the rack position offset value. For example, the s controller 100 may synchronize the rack to a handwheel angle zero position or other suitable position.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

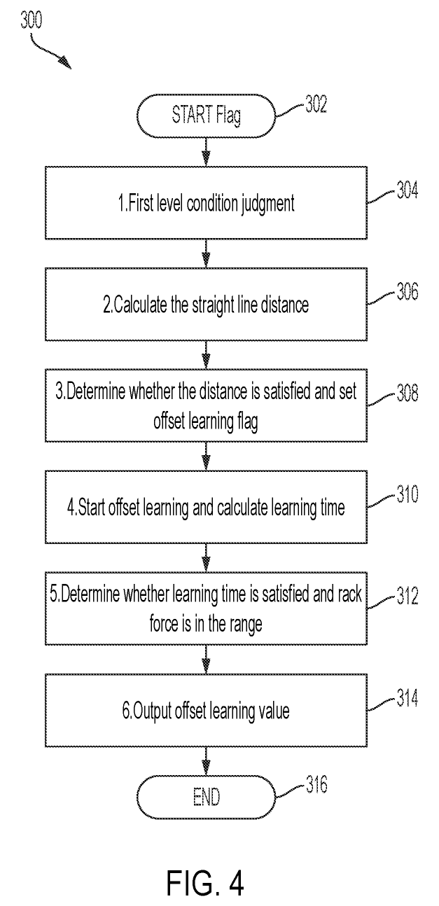

FIG. 4 is a flow diagram generally illustrated a rack position offset learning method 300 according to the principles of the present disclosure. At 302, the method 300 begins.

At 304, the method 300 performs a first level condition judgement. For example, the method 300 predicts whether at least one condition is met. If the first level condition is not met, the method 300 does not initiate a rack position offset learning function. Alternatively, if the first level condition is met, the method 300 initiates the rack position learning offset function. The first level condition may be determined based on any suitable combination of rack position, rack velocity, rack force, vehicle speed, and vehicle yaw rate. The method 300 may set a flag (e.g., in an associated memory of the controller 100) in response to the first level condition being met.

At 306, the method 300 calculates the straight line distance. For example, in response to the flag being set (e.g., the first level condition being met), the method 300 determines that the vehicle is traveling in a straight line or a substantially straight line. The method 300 then calculates the straight line distance of the vehicle 10 based on the vehicle speed and drive time.

At 308, the method 300 determines whether the distance is satisfied and sets an offset learning flag. For example, after a predetermined period (e.g., three minutes or other suitable period), the method 300 compares the distance to a calibration value to determine whether the distance is long enough to set the offset learning flag.

At 310, the method 300 starts the offset learning and calculates a learning time. For example, the method 300 may use a low pass filter-low pass filter (LPF-LPF filter) to limit the offset value. The method 300 may determine a counter accumulation.

At 312, the method 300 determines whether the learning time (e.g., counter accumulation) is satisfied and rack force is within a range. For example, if he counter accumulation value is greater than or equal to the time threshold, and the rack force is less than the rack force threshold, the method 300 sets an output flag.

At 314, the method 300 outputs an offset learning value. For example, the method 300 may output the LPF-LPF filter value and limit the final offset value.

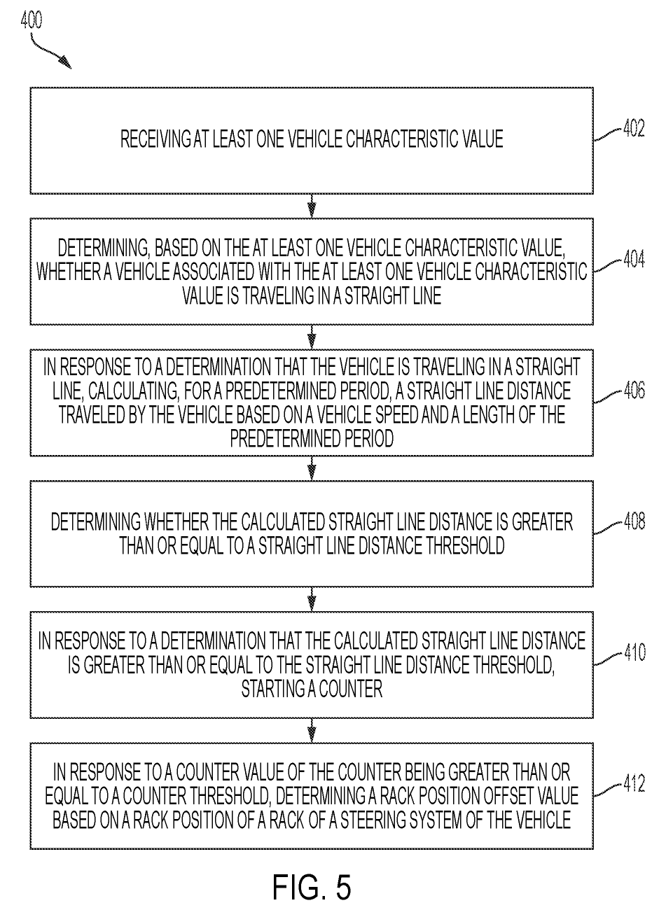

FIG. 5 is a flow diagram generally illustrating an alternative rack position offset learning method 400 according to the principles of the present disclosure. At 402, the method 400 receives at least one vehicle characteristic value.

At 404, the method 400 determines, based on the at least one vehicle characteristic value, whether a vehicle associated with the at least one vehicle characteristic value is traveling in a straight line.

At 406, the method 400, in response to a determination that the vehicle is traveling in a straight line, calculates, for a predetermine period, a straight line distance traveled by the vehicle based on a vehicle speed and a length of the predetermined period.

At 408, the method 400 determines whether the calculated straight line distance is greater than or equal to a straight line distance threshold.

At 410, the method 400, in response to a determination that the calculated straight line distance is greater than or equal to the straight line distance threshold, starts a counter.

At 412, the method 400, in response to a counter value of the counter being greater than or equal to a counter threshold, determines a rack position offset value based on a rack position of a rack of a steering system of the vehicle.

In some embodiments, a system for rack position offset learning includes a processor, and a memory. The memory includes instructions that, when executed by the processor, cause the processor to: receive at least one vehicle characteristic value; determine, based on the at least one vehicle characteristic value, whether a vehicle associated with the at least one vehicle characteristic value is traveling in a straight line; in response to a determination that the vehicle is traveling in a straight line, calculate, for a predetermine period, a straight line distance traveled by the vehicle based on a vehicle speed and a length of the predetermined period; determine whether the calculated straight line distance is greater than or equal to a straight line distance threshold; in response to a determination that the calculated straight line distance is greater than or equal to the straight line distance threshold, start a counter; and, in response to a counter value of the counter being greater than or equal to a counter threshold, determine a rack position offset value based on a rack position of a rack of a steering system of the vehicle.

In some embodiments, the rack position of the rack corresponds to a zero position of the rack. In some embodiments, the instructions further cause the processor to adjust a position of the rack based on the rack position offset value. In some embodiments, adjusting the position of the rack includes synchronizing the rack to a handwheel angle zero position. In some embodiments, the at least one vehicle characteristic includes at least the rack position. In some embodiments, the at least one vehicle characteristic includes at least the vehicle speed. In some embodiments, the at least one vehicle characteristic includes at least a rack velocity of the rack, a rack force of the rack, and a vehicle yaw rate. In some embodiments, the steering system includes a steer-by-wire steering system. In some embodiments, the instructions further cause the processor to determine the rack position offset value based on the rack position of the rack of the steering system of the vehicle using at least one low pass filter. In some embodiments, the instructions further cause the processor to use the low pass filter to limit the rack position offset value.

In some embodiments, a method for rack position offset learning includes receiving at least one vehicle characteristic value, and determining, based on the at least one vehicle characteristic value, whether a vehicle associated with the at least one vehicle characteristic value is traveling in a straight line. The method also includes, in response to a determination that the vehicle is traveling in a straight line, calculating, for a predetermine period, a straight line distance traveled by the vehicle based on a vehicle speed and a length of the predetermined period. The method also includes determining whether the calculated straight line distance is greater than or equal to a straight line distance threshold, in response to a determination that the calculated straight line distance is greater than or equal to the straight line distance threshold, starting a counter, and, in response to a counter value of the counter being greater than or equal to a counter threshold, determining a rack position offset value based on a rack position of a rack of a steering system of the vehicle.

In some embodiments, the rack position of the rack corresponds to a zero position of the rack. In some embodiments, the method also includes adjusting a position of the rack based on the rack position offset value. In some embodiments, adjusting the position of the rack includes synchronizing the rack to a handwheel angle zero position. In some embodiments, the at least one vehicle characteristic includes at least the rack position. In some embodiments, the at least one vehicle characteristic includes at least the vehicle speed. In some embodiments, the at least one vehicle characteristic includes at least a rack velocity of the rack, a rack force of the rack, and a vehicle yaw rate. In some embodiments, determining the rack position offset value based on the rack position of the rack of the steering system of the vehicle includes using at least one low pass filter. In some embodiments, the method also includes using the low pass filter to limit the rack position offset value.

In some embodiments, an apparatus for rack position offset learning includes a controller configured to: receive at least one vehicle characteristic value; determine, based on the at least one vehicle characteristic value, whether a vehicle associated with the at least one vehicle characteristic value is traveling in a straight line; in response to a determination that the vehicle is traveling in a straight line, calculate, for a predetermine period, a straight line distance traveled by the vehicle based on a vehicle speed and a length of the predetermined period; determine whether the calculated straight line distance is greater than or equal to a straight line distance threshold; in response to a determination that the calculated straight line distance is greater than or equal to the straight line distance threshold, start a counter; in response to a counter value of the counter being greater than or equal to a counter threshold, determine a rack position offset value based on a rack position of a rack of a steering system of the vehicle; and adjust a position of the rack based on the rack position offset value.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A system for rack position offset learning, the system comprising:
a processor; and
a memory including instructions that, when executed by the processor, cause the processor to:
receive at least one vehicle characteristic value;
determine, based on the at least one vehicle characteristic value, whether a vehicle associated with the at least one vehicle characteristic value is traveling in a straight line;
in response to a determination that the vehicle is traveling in a straight line, calculate, for a predetermine period, a straight line distance traveled by the vehicle based on a vehicle speed and a length of the predetermined period;
determine whether the calculated straight line distance is greater than or equal to a straight line distance threshold;
in response to a determination that the calculated straight line distance is greater than or equal to the straight line distance threshold, start a counter; and
in response to a counter value of the counter being greater than or equal to a counter threshold, determine a rack position offset value based on a rack position of a rack of a steering system of the vehicle.

2. The system of claim 1, wherein the rack position of the rack corresponds to a zero position of the rack.

3. The system of claim 2, wherein the instructions further cause the processor to adjust a position of the rack based on the rack position offset value.

4. The system of claim 3, wherein adjusting the position of the rack includes synchronizing the rack to a handwheel angle zero position.

5. The system of claim 1, wherein the at least one vehicle characteristic includes at least the rack position.

6. The system of claim 1, wherein the at least one vehicle characteristic includes at least the vehicle speed.

7. The system of claim 1, wherein the at least one vehicle characteristic includes at least a rack velocity of the rack, a rack force of the rack, and a vehicle yaw rate.

8. The system of claim 1, wherein the steering system includes a steer-by-wire steering system.

9. The system of claim 1, wherein instructions further cause the processor to determine the rack position offset value based on the rack position of the rack of the steering system of the vehicle using at least one low pass filter.

10. The system of claim 9, wherein the instructions further cause the processor to use the low pass filter to limit the rack position offset value.

11. A method for rack position offset learning, the method comprising:
receiving at least one vehicle characteristic value;
determining, based on the at least one vehicle characteristic value, whether a vehicle associated with the at least one vehicle characteristic value is traveling in a straight line;
in response to a determination that the vehicle is traveling in a straight line, calculating, for a predetermine period, a straight line distance traveled by the vehicle based on a vehicle speed and a length of the predetermined period;
determining whether the calculated straight line distance is greater than or equal to a straight line distance threshold;
in response to a determination that the calculated straight line distance is greater than or equal to the straight line distance threshold, starting a counter; and
in response to a counter value of the counter being greater than or equal to a counter threshold, determining a rack position offset value based on a rack position of a rack of a steering system of the vehicle.

12. The method of claim 11, wherein the rack position of the rack corresponds to a zero position of the rack.

13. The method of claim 12, further comprising adjusting a position of the rack based on the rack position offset value.

14. The method of claim 13, wherein adjusting the position of the rack includes synchronizing the rack to a handwheel angle zero position.

15. The method of claim 11, wherein the at least one vehicle characteristic includes at least the rack position.

16. The method of claim 11, wherein the at least one vehicle characteristic includes at least the vehicle speed.

17. The method of claim 11, wherein the at least one vehicle characteristic includes at least a rack velocity of the rack, a rack force of the rack, and a vehicle yaw rate.

18. The method of claim 11, wherein determining the rack position offset value based on the rack position of the rack of the steering system of the vehicle includes using at least one low pass filter.

19. The method of claim 18, further comprising using the low pass filter to limit the rack position offset value.

20. An apparatus for rack position offset learning, the apparatus comprising:
a controller configured to:
receive at least one vehicle characteristic value;
determine, based on the at least one vehicle characteristic value, whether a vehicle associated with the at least one vehicle characteristic value is traveling in a straight line;
in response to a determination that the vehicle is traveling in a straight line, calculate, for a predetermine period, a straight line distance traveled by the vehicle based on a vehicle speed and a length of the predetermined period;
determine whether the calculated straight line distance is greater than or equal to a straight line distance threshold;
in response to a determination that the calculated straight line distance is greater than or equal to the straight line distance threshold, start a counter;
in response to a counter value of the counter being greater than or equal to a counter threshold, determine a rack position offset value based on a rack position of a rack of a steering system of the vehicle; and
adjust a position of the rack based on the rack position offset value.
